(19) United States
(12) Patent Application Publication
(10) Pub. No.: US 2007/0002222 A1
(43) Pub. Date: Jan. 4, 2007

(54) Method for manufacturing transflective liquid crystal display

(75) Inventors: Byoung Ho Lim, Gyeongsangbuk-do (KR); Byeong Dae Choi, Daegu (KR); Hae Jin Yun, Gyeongsangbuk-do (KR); Woong Sik Kim, Gyeonggi-do (KR)

Correspondence Address: MORGAN LEWIS & BOCKIUS LLP, 1111 PENNSYLVANIA AVENUE NW, WASHINGTON, DC, 20004, US

(73) Assignee: LG. Philips Co., Ltd.

(21) Appl. No.: 11/293,503

(22) Filed: Dec. 5, 2005

(30) Foreign Application Priority Data
Jun. 30, 2005 (KR) P2005-058620

(51) Int. Cl. G02F 1/1335

(52) U.S. Cl. 349/114

(57) ABSTRACT

A method for manufacturing a transflective LCD includes forming a gate line and a gate pad extending from the gate line on a substrate, forming an gate insulation layer over an entire surface of the substrate, forming a data line and a data pad extending from the data line, the data line crossing the gate line to define a unit pixel, forming a thin film transistor at the crossing of the gate line and the data line, forming a passivation layer over an entire surface of the substrate including the thin film transistor, patterning the passivation layer to form a plurality of contact holes each exposing a corresponding drain electrode, the gate pad, and the data pad of the thin film transistor, forming a transmissive electrode at a transmissive portion in the unit pixel region on the passivation layer, forming a reflective electrode at a reflective portion in the unit pixel region on the passivation layer, and forming an oxidation prevention layer including a transparent conductive film and a metal layer, wherein the oxidation prevention layer contacts the gate pad and the data pad through the contact hole.

The present application claims the benefit of Korean Patent Application No. P2005-58620, filed in Korea on Jun. 30, 2005, which is hereby incorporated by reference as if fully set forth herein.

### BACKGROUND OF THE INVENTION

1. Field of the Invention

The present invention relates to a liquid crystal display device, and more particularly, to a method for manufacturing a transflective liquid crystal display device.

2. Discussion of the Related Art

Recently, various flat panel display devices, such as liquid crystal display (LCD) devices, field emission display (FED) devices, electroluminescence devices (ELDs), and plasma display panel (PDP) devices, have been actively developed. In particular, the LCD devices have been increasingly incorporated into flat panel display devices because of their large contrast ratio, adaptability for displaying of multiple levels of grey and dynamic images, and low power consumption.

The LCD devices can be classified into two types including a backlit LCD device that uses a backlight as a light source, and a reflective LCD device that uses external natural light as the light source. The backlit LCD device is beneficial for displaying bright images in relatively dark places, but it requires large power consumption. The reflective LCD device is attractive because it is low in power consumption since it does not use a backlight, but it has a problem in that it cannot be used in dark places. Thus, in general, the reflective LCD devices are incorporated in relatively small electronic devices, such as watches or calculators, that require minimal power consumption, whereas the backlit LCD devices are commonly employed in notebook computers that require large-sized displays and high quality images.

Recently, the development of transflective LCD devices has increased that can overcome the problems associated with the reflective LCD devices and the backlit LCD devices. Since the transflective LCD devices include reflective and transmissive portions within a unit pixel region, they can be employed in devices that require both reflective and backlit LCD devices. For example, when external light is of sufficient brightness that the LCD device can display images without the use of the backlight, the transflective LCD device can function as the reflective LCD device by reflecting external light incident through an upper panel by a reflective electrode formed at the reflective portion of the unit pixel region. On the other hand, when an external light is not of sufficient brightness, the transflective LCD device uses the backlight and functions as the backlit LCD device by allowing light of the backlight to enter a liquid crystal layer through the transmissive portion of the unit pixel region where the reflective electrode is not formed.

In general, the transflective LCD device comprises a thin film transistor (TFT) array substrate that includes the reflective and transmissive portions within each unit pixel region, a color filter (CF) array substrate that includes a color filter layer formed thereon, and a liquid crystal layer between the TFT and CF substrates. The TFT array substrate is divided into an active region and a pad region, wherein the active region comprises a gate line and a data line formed in a matrix configuration on a transparent substrate to form a plurality of the unit pixel regions. In addition, a TFT is formed at a portion where the gate lines and the data lines cross each other, a transmissive electrode is formed on the transmissive portion of the unit pixel region while being electrically connected to the TFT, and a reflective electrode is formed at the reflective portion of the unit pixel region while being electrically connected to the TFT or a pixel electrode.

The pad region of the TFT array substrate is positioned outside of the active region, and includes a gate pad extending from each of the gate lines and a data pad extending from each of the data lines. The gate pads and the data pads are connected to an external drive circuit that is connected to a drive IC to supply various video signals and control signals to the gate and data lines.

FIGS. 1A to 1F are cross-sectional views of a method for manufacturing a transflective LCD device according to the related art. In FIG. 1A, after depositing a first metal layer of Mo and AlNd on a transparent substrate 11 made of glass or quartz, a gate line (not shown), a gate electrode 12, and a gate pad 22 are formed on the first metal layer via photo-etching technique using a first mask.

In FIG. 1B, a gate insulation layer 13 is formed over the entire surface of the transparent substrate 11 including the gate electrode 12 by depositing silicon nitride on the transparent substrate 11. Then, an amorphous silicon layer and a second metal layer are sequentially formed over the entire surface of the transparent substrate 11 including the gate insulation layer 13. Next, a semiconductor layer 14, a data line 15, source/drain electrodes 15a/15b, and a data pad (not shown) are simultaneously formed on the gate insulation layer 13 by patterning the second metal layer and the amorphous silicon layer through the photolithographic etching technique using a second mask (diffractive exposure mask).

At this time, the data line crosses the gate line to define a unit pixel region, and the source/drain electrodes 15a/15b are formed respectively at opposite ends of the semiconductor layer 14, thereby constituting the TFT that includes the gate electrode 12, the semiconductor layer 14, and the source/drain electrodes 15a/15b sequentially stacked thereon. For example, the semiconductor layer and the data line can be formed through a patterning process using the mask once, as described above, or using the patterning process using the mask twice. At this time, when simultaneously forming the semiconductor layer and the data line through the patterning process using the mask once, the diffractive exposure mask is used.

In FIG. 1C, a passivation layer 16 is formed over the entire surface of the transparent substrate 11 including the TFT on the transparent substrate 11 by coating an organic insulation material or depositing a inorganic insulation material. Then, another organic insulation material is coated or another inorganic insulation material is deposited over the passivation layer 16 to form an insulation layer 40. Next, an embossing process forms a plurality of grooved patterns at equal intervals on the surface of the insulation layer 40 through the photo-etching technique using a third mask.

At the same time, first and second contact holes 18 and 19, and an open region 20 are formed. Here, the first contact hole 18 is formed by removing the insulation layer 40 and the passivation layer 16 with the drain electrode 15b acting as an etching stop layer. The second contact hole 19 is formed by removing the insulation layer 40, the passivation layer 16, and the gate insulation layer 13 with the gate pad 22 acting as an etching stop layer. The open region 20 is formed by removing the insulation layer 40, the passivation layer 16, and the gate insulation layer 13 with the substrate 11 acting as an etching stop layer. Although not shown in the drawings, the data pad is also exposed to the outside by removing the insulation layer and the passivation layer on the data pad in the pad region. For reference, the open region is formed in order to make a cell gap of the transmission part twice as wide as that of the reflection part.

In FIG. 1D, a transparent conductive material of indium tin oxide (ITO), Mo, and AlNd are sequentially deposited over the entire surface of the transparent substrate 11 including the grooved insulation layer 40 to form a transparent conductive film 17a, a third metal layer 24a, and a fourth metal layer 24b. Then, patterning is performed through the photo-etching technique using a fourth mask (diffractive exposure mask) to form a transparent electrode and a reflective electrode. Specifically, after a photoresist 50 is coated to a uniform thickness on the fourth metal layer 24b, and covered and exposed with the diffractive exposure mask, the photoresist 50 is developed to have double steps by diffractive exposure using the diffractive exposure mask. The diffractive exposure mask is divided into three regions including a transparent region, a translucent region, and a light shielding region in which the transparent region has a light transmittance of 100%, and the light shielding region is formed with a light shielding layer and has a light transmittance of 0%, and the translucent region is formed with a translucent layer and has a light transmittance of 0-100%.

As a result, a thickness of the photoresist subjected to the development by the diffractive exposure is also divided into three sections including a completely exposed section I corresponding to the transparent region of the diffractive exposure mask, a completely non-exposed section II corresponding to the light shielding region of the mask, and a diffractively exposed section III corresponding to the translucent region of the mask. As such, the diffractively exposed photoresist is completely eliminated only at the completely exposed section, becomes a thin layer only at the diffractively exposed section, and remains in its original state only at the completely non-exposed section. At this time, the diffractively exposed section III corresponds to a region where the reflective electrode of the active region and the oxidation prevention layer of the pad region will be formed, while the completely non-exposed section II corresponds to a region where the transmissive electrode of the active region will be formed. Next, the fourth metal layer 24b, the third metal layer 24a, and the transparent conductive film 17a are sequentially removed by wet etching with the photoresist 50 acting as the mask in which the photoresist 50 is patterned via the diffractive exposure.

In FIG. 1E, the transmissive portion of the active region and a predetermined portion of the pad region are exposed by ashing the photoresist 50 until the photoresist 50 of the diffractively exposed section is removed, and the fourth metal layer 24b and the third metal layer 24a are etched using the ashen photoresist 50 as the mask. At this time, the transparent conductive film is prevented from being etched by using a mixed acid.

In FIG. 1F, when the photoresist 50 is stripped off, a transmissive electrode 17 consisting of the transparent conductive film is formed on the transmission part T of the active region, a reflective electrode 24 consisting of the third and fourth metal layers 24a and 24b is formed at the reflection part R of the active region, and an oxidation prevention layer 60 consisting of the transparent conductive film is formed on the gate pad 22 and the data pad of the pad region.

Accordingly, the TFT array substrate of the transflective LCD device is generally formed via the photo-etching technique using the mask at least four times for the processes of forming the gate line (first mask), the semiconductor layer, and the data line (second mask), the process of embossing the insulation layer (third mask), and the processes of forming the transmissive electrode, the reflective electrode, and the oxidation prevention layer (fourth mask). However, the method for manufacturing the transflective LCD device according to the related art described above is problematic.

During the process of forming the oxidation prevention layer using the fourth mask, wet etching is performed to remove the third and fourth metal layers on the oxidation prevention layer, and at this time, an etchant for etching the metal layer is selectively used to prevent the oxidation prevention layer from being wet-etched. However, when defective patterns are formed on the oxidation prevention layer during the process of wet etching the third and fourth metal layers, the oxidation prevention layer does not positively act as a passivation layer of the pad electrode on the pad region, whereby the etchant penetrates the oxidation prevention layer, thereby eroding the pad electrode. In particular, when the pad electrode is constituted by a single metal layer, there is a possibility of cut-off of the pad electrode.

### SUMMARY OF THE INVENTION

Accordingly, the present invention is directed to a method for manufacturing a transflective LCD device that substantially obviates one or more problems due to limitations and disadvantages of the related art.

An object of the present invention is to provide a method for manufacturing a transflective LCD device for preventing etchant erosion of a pad electrode.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for manufacturing a transflective LCD includes forming a gate line and a gate pad extending from the gate line on a substrate, forming an gate insulation layer over an entire surface of the substrate, forming a data line and a data pad extending from the data line, the data line crossing the gate line to define a unit pixel, forming a thin film transistor at the crossing of the gate line and the data line, forming a passivation layer over an entire surface of the substrate including the thin film transistor, patterning the passivation layer to form a plurality of contact holes each exposing a corresponding drain electrode, the gate pad, and the data pad of the thin film transistor, forming a transmissive electrode at a transmissive portion in the unit pixel region on the passivation layer, forming a reflective electrode at a reflective portion in the unit pixel region on the passivation layer, and forming an oxidation prevention layer including a transparent conductive film and a metal layer, wherein the oxidation prevention layer contacts the gate pad and the data pad through the contact hole.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIGS. 1A to 1F are cross-sectional views of a method for manufacturing a transflective LCD device according to the related art; and

FIGS. 2A to 2F are cross-sectional views of an exemplary method for manufacturing a transflective LCD device in accordance with the present invention.

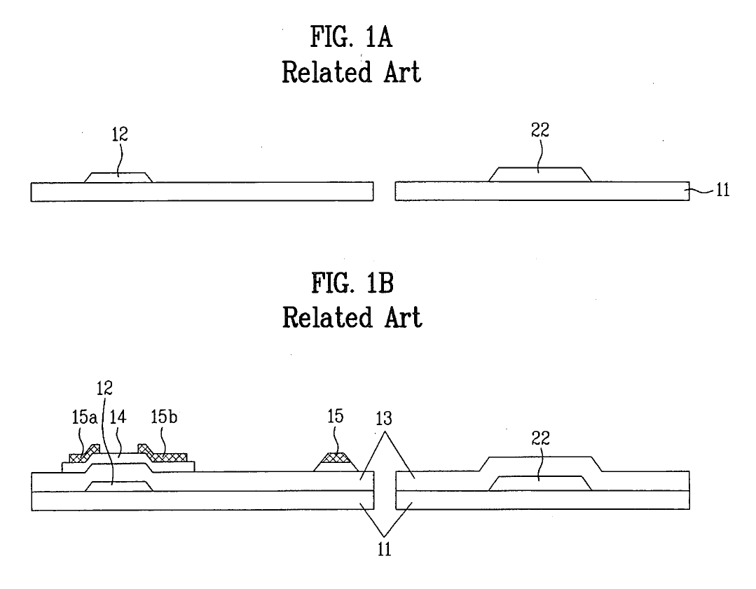

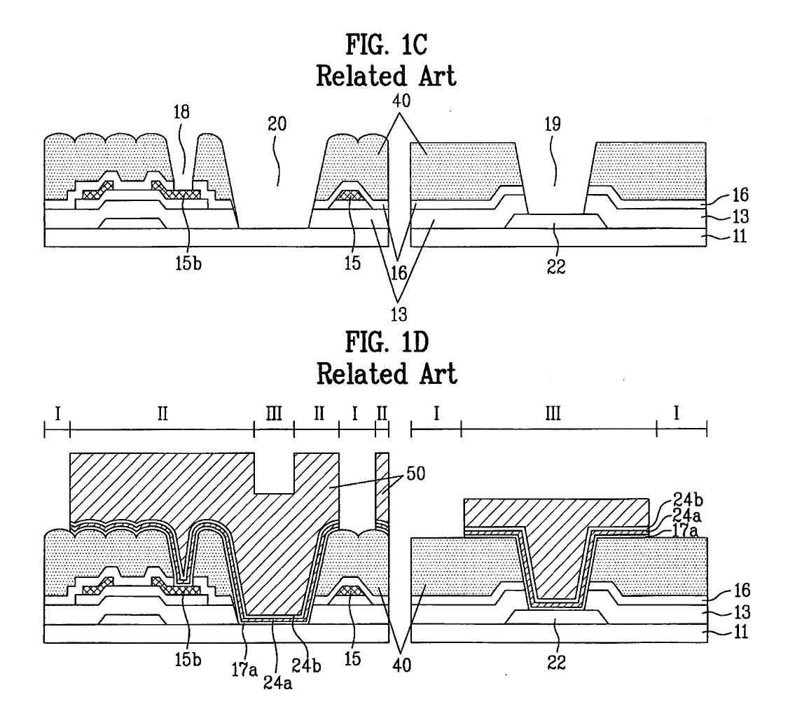

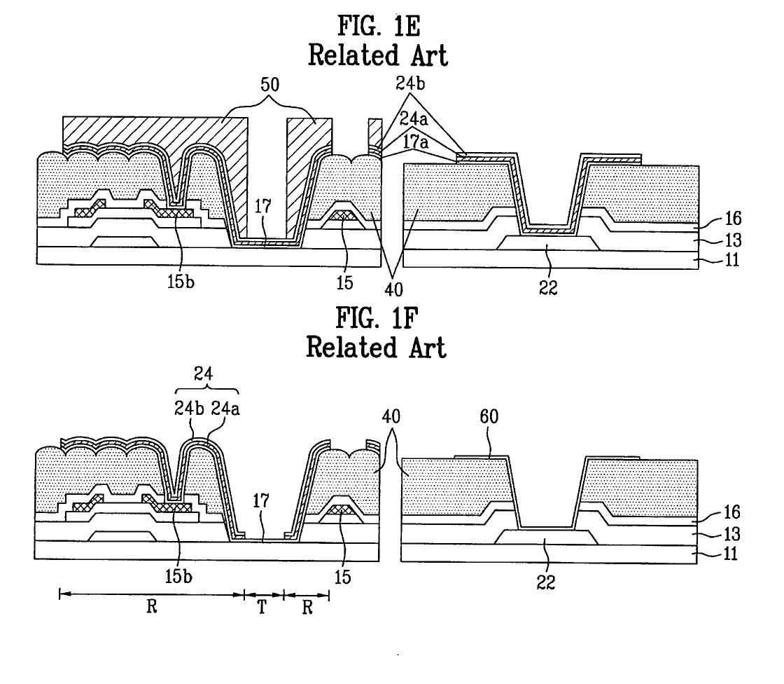

### DETAILED DESCRIPTION OF THE PREFERRED EMBODIMENTS

Reference will now be made in detail to the preferred embodiments of the present invention, examples of which are illustrated in the accompanying drawings.

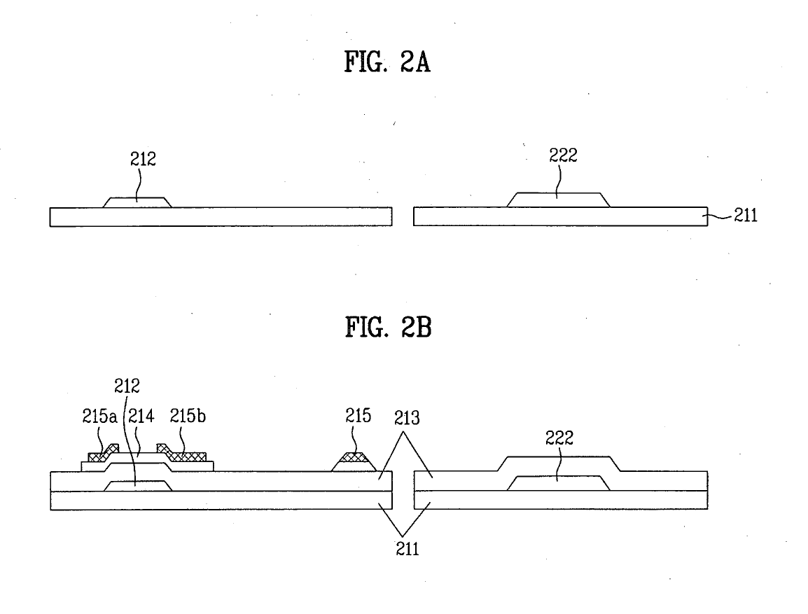

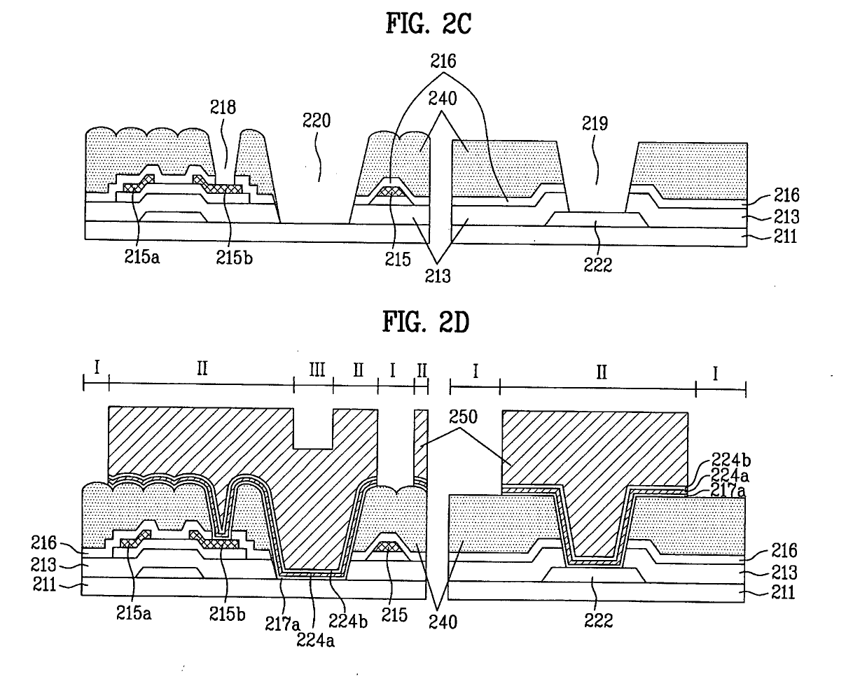

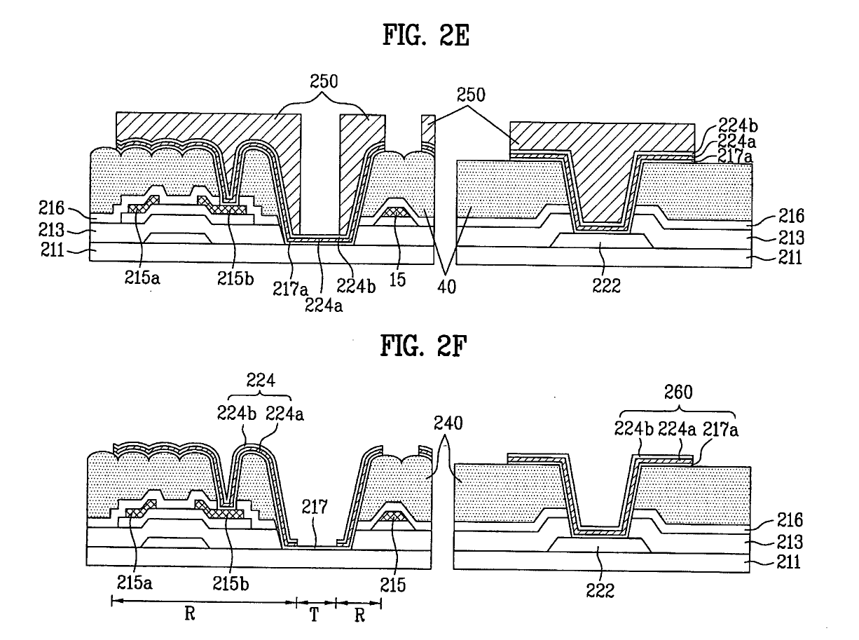

FIGS. 2A to 2F are cross-sectional views of an exemplary method for manufacturing a transflective LCD device in accordance with the present invention. In FIG. 2A, after depositing a first metal layer, such as Cu, Al, Al alloy (AlNd), Mo, Cr, Ti, Ta, MoW, etc., on an insulating substrate 211, patterning is performed via photo-etching technique using a first mask to form a gate line (not shown) and a gate electrode 212 on an active region, and a gate pad 222 on a pad region. At this time, the gate line, the gate electrode, and the gate pad are integrally connected.

In FIG. 2B, a gate insulation layer 213 is formed by depositing a inorganic insulation material, such as a silicon oxide (SiOₓ) or a silicon nitride (SiNₓ), over the entire surface of the insulating substrate 211 including the gate electrode 212 using a Plasma Enhanced Chemical Vapor Deposition (PECVD) process. Next, an amorphous silicon layer and an n⁺-doped amorphous silicon layer (later to form an ohmic contact layer) are sequentially formed on the gate insulation layer 213. Then, a second metal layer of a predetermined material, such as Cu, Al, Al alloy (AlNd), Mo, Cr, Ti, Ta, MoW, etc., is deposited thereon, followed by simultaneous patterning by the photo-etching technique using a second mask (diffractive exposure mask) to form a semiconductor layer 214, a data line 215, and source/drain electrodes 215a/215b on the active region, and a data pad (not shown) on the pad region.

Specifically, after forming a two-stepped photoresist having a diffractively exposed section corresponding to a channel layer between a source electrode and a data electrode on the second metal layer, the semiconductor layer 214, the data line 215, and the source/drain electrodes 215a/215b are formed by simultaneously etching the second metal layer, the amorphous silicon layer, and the ohmic contact layer exposed through the photoresist, and the data pad (not shown) is formed in the pad region. Then, after ashing the photoresist until a lower-stepped photoresist is removed to expose the second metal layer, the second metal layer and the ohmic contact layer partially exposed through the ashed photoresist are etched to define the channel layer. As a result, the data line 215 is formed to vertically cross the gate line, and the source/drain electrodes 215a and 215b are formed above the gate electrode 212. In addition, the semiconductor layer 214 is formed under the source/drain electrodes 215a and 215b. Here, stacked layers of the gate electrode 212, the gate insulation layer 213, the semiconductor layer 214, the ohmic contact layer (not shown), and the source/drain electrodes 215a and 215b constitute a TFT.

In FIG. 2C, a passivation layer 216 is formed over the entire surface of the insulating substrate 211 including the TFT by coating an inorganic insulation material, such as a silicon nitride or a silicon oxide, or by depositing an organic insulation material, such as benzocyclobutene (BCB) or an acrylic resin, thereon, and an insulation layer 240 for forming grooved patterns is formed on the passivation layer 216 by coating or depositing inorganic or organic insulation material. Then, the surface of the insulation layer 240 is grooved by the photo-etching technique using a third mask to form a plurality of grooved patterns at predetermined intervals on a reflection part in a unit pixel region, followed by reflow of the grooved patterns of the insulation layer.

As shown in FIG. 2C, an open region 220 is formed by dry-etching the insulation layer 240, the passivation layer 216, and the gate insulation layer 213 in the transmissive portion of the unit pixel region. Then, a first contact hole 218 is formed by removing the insulation layer 240 and the passivation layer 216 with the drain electrode 215b acting as an etching stop layer, and a second contact hole 219 is formed by removing the insulation layer 240, the passivation layer 216, and the gate insulation layer 213 with the gate pad 222 acting as an etching stop layer. Although not shown in the drawings, the data pad is also exposed by removing the insulation layer 240 and the passivation layer 216 on the data pad in the pad region.

In FIG. 2D, a transparent conductive film 217a, a third metal layer 224a, and a fourth metal layer 224b are sequentially deposited over the entire surface of the insulating substrate 211 including the insulation layer 240 having the grooved patterns. Then, patterning is performed through the photo-etching technique using a fourth mask (diffractive exposure mask) to form a transparent electrode and a reflective electrode on the active region, and to form an oxidation prevention layer comprising a transparent conductive film and the metal layer on the pad region. At this time, the transparent conductive film is formed of a transparent conductive material, such as ITO or indium zinc oxide (IZO). The third and fourth metal layers are formed of a material selected from Cu, Al, Al alloy (AlNd), Mo, Cr, Ti, Ta, and MoW.

As shown in FIG. 2D, after a photoresist 250 is coated to a uniform thickness on the fourth metal layer 224b and is covered with a diffractive exposure mask, the photoresist 250 is developed to have double steps by diffractive exposure using the mask. The diffractive exposure mask is divided into three regions including a transparent region, a translucent region, and a light shielding region, in which the transparent region has a light transmittance of 100%, and the light shielding region is formed with a light shielding layer and has a light transmittance of 0%, and the translucent region is formed with a translucent layer and has a light transmittance of 0˜100%. As a result, a thickness of the photoresist 250 subjected to the development by the diffractive exposure is also divided into three sections including a completely exposed section I corresponding to the transparent region of the diffractive exposure mask, a completely non-exposed section II corresponding to the light shielding region of the mask, and a diffractively exposed section III corresponding to the translucent region of the mask. As such, the diffractively exposed photoresist is completely eliminated only at the completely exposed section I, becomes a thin layer only at the diffractively exposed section III, and remains in its original state only at the completely non-exposed section II. At this time, the diffractively exposed section III corresponds to the reflective portion of the active region, while the completely non-exposed section II corresponds to a region wherein the transmissive portion of the active region and the oxidation prevention layer of the pad region will be formed. Next, the fourth metal layer 224b, the third metal layer 224a, and the transparent conductive film 217a are sequentially etched by wet etching using a mixed acid and an acid with the photoresist 250 acting as the mask in which the photoresist 250 is patterned via the diffractive exposure.

In FIG. 2E, the photoresist 250 is ashed until the fourth metal layer of the transmissive portion is exposed, and the fourth and third metal layers 24b and 24a at the transmissive portion are etched using the ashed photoresist 250 as the mask such that only the transparent conductive film remains, thereby forming a transmissive electrode. At this time, in order to selectively etch only the metal layer, wet etching is performed using Hydrofluoric acid (HF), Buffered Oxide Etchant (BOE), NH₄F or a mixture thereof. As for the wet etching, there are a dipping type wet etching in which the substrate is immersed into a bath filled with a chemical solution, and a spray type wet etching in which the chemical solution is sprayed onto the substrate.

In FIG. 2F, when the photoresist is stripped off, the transmissive electrode 217 electrically connected to the drain electrode 215b and consisting of the transparent conductive film is formed at the transmission part T of the active region, and a reflective electrode 224 electrically connected to the drain electrode 215b via the transparent conductive film and consisting of the third and fourth metal layers 224a and 224b is formed at the reflection part R of the active region. In addition, an oxidation prevention layer 260 consisting of stacked layers of the transparent conductive film 217a, the third metal layer 224a, and the fourth metal layer 224b is formed on the pad region. The oxidation prevention layer 260 contacts the gate pad 222 and the data pad (not shown), and prevents corrosion of the pad electrode.

At this time, the reflective electrode 224 is formed along curved features of the grooved pattern formed at the reflection part, and thus has a grooved surface. The grooved surface of the reflective electrode acts to widen a viewing angle by locally changing a reflection angle of external natural light when using external natural light as a light source. At this time, in addition to defining the area of the reflective electrode only to the reflective part of the unit pixel region, the reflective electrode may be formed to overlap the gate line, the data line and the thin film transistor in order to prevent light leakage. Accordingly, the reflective electrode is formed of metal having a high light reflectance at the reflective portion in the unit pixel region, while the transmissive electrode is formed of the transparent conductive material at the transmissive portion in the unit pixel region, thereby providing a combinational function of reflective type and backlit type.

Meanwhile, since the pad region is exposed for connection with an external drive circuit, and the surface of the oxidation prevention layer 260 is composed of the metal layer, the oxidation pervention treatment is required to prevent oxidation of the metal layer. For example, the surface of the oxidation prevention layer is forcibly oxidized by annealing the substrate at a predetermined temperature in oxygen or nitrogen atmosphere. In the case where the surface metal layer of the oxidation prevention layer is composed of AlNd, the metal layer becomes Al₂O₃ by the forced oxidation, thereby preventing natural oxidation of the oxidation prevention layer. As a result, it is possible to eliminate the process of removing the upper metal layer, which is required to form the oxidation prevention layer only with the transparent conductive film. Thus, it is possible to prevent formation of a defective pattern of the transparent conductive film which can be formed during wet-etching of the upper metal layer, and to prevent corrosion of the pad electrode due to penetration of the etchant.

According to the present invention, a transflective LCD device is formed using the mask four times. However, even when forming the transflective LCD device using the mask five times or more, it is possible to prevent the corrosion of the pad electrode caused by etching of the metal layer in such a way of forming the oxidation prevention layer in the pad region with the metal layer and the transparent conductive film. Specifically, in the process using the mask four times, the transmissive electrode, the reflective electrode, and the oxidation prevention layer are formed simultaneously by performing the photo-etching once. Additionally, when forming the transmissive electrode, the reflective electrode, and the oxidation prevention layer using the mask twice, it is possible to apply the present invention.

A process of forming the transmissive electrode, the reflective electrode, and the oxidation prevention layer by performing the photo-etching twice comprises the steps of: depositing a transparent conductive film on a passivation layer; patterning the transparent conductive film to form a transmissive electrode and a first oxidation prevention layer; depositing a metal layer over an entire surface including the transmissive electrode and the first oxidation prevention layer; and patterning the transparent conductive film to form a reflective electrode, followed by forming a second oxidation prevention layer on the first oxidation prevention layer. At this time, by forming the second oxidation prevention layer on the first oxidation prevention layer, the first oxidation prevention layer becomes the transparent conductive film, and the second oxidation prevention layer becomes the metal layer. In this process, it is also possible to prevent the corrosion of the pad electrode which can occur during removal of the metal layer in such a way of oxidation pervention treatment of the second oxidation prevention layer (metal layer) instead of removing the second oxidation prevention layer.

According to the present invention, a method for manufacturing a transflective LCD device has advantageous effects. For example, when depositing the metal layer for the reflective electrode, the metal layer is also deposited on the oxidation prevention layer of the pad electrode in the pad region. In this case, the metal layer on the oxidation prevention layer is subjected to the surface oxidation treatment, thereby eliminating the process of removing the metal layer. As a result, it is possible to prevent formation of a defective pattern of the transparent conductive film which can be formed during wet-etching of the metal layer of the oxidation prevention layer, and to prevent corrosion of the pad electrode due to penetration of an etchant into the pad electrode.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for manufacturing a transflective liquid crystal display device, comprising the steps of:
forming a gate line and a gate pad extending from the gate line on a substrate;
forming an gate insulation layer over an entire surface of the substrate;
forming a data line and a data pad extending from the data line, the data line crossing the gate line to define a unit pixel;
forming a thin film transistor at the crossing of the gate line and the data line;
forming a passivation layer over an entire surface of the substrate including the thin film transistor;
patterning the passivation layer to form a plurality of contact holes each exposing a corresponding drain electrode of the thin film transistor, the gate pad, and the data pad;
forming a transmissive electrode at a transmissive portion in the unit pixel region on the passivation layer;
forming a reflective electrode at a reflective portion in the unit pixel region on the passivation layer; and
forming an oxidation prevention layer including a transparent conductive film and a metal layer,
wherein the oxidation prevention layer contacts the gate pad and the data pad through the contact hole.

2. The method according to claim 1, further comprising performing a oxidation prevention treatment on the metal layer of the oxidation prevention layer.

3. The method according to claim 2, wherein the oxidation pervention treatment of the oxidation prevention layer is performed by annealing in one of an oxygen atmosphere and a nitrogen atmosphere.

4. The method according to claim 1, wherein the transmissive electrode, the reflective electrode, and the oxidation prevention layer are simultaneously formed by performing a photo-etching once.

5. The method according to claim 4, wherein the step of simultaneously forming the transmissive electrode, the reflective electrode, and the oxidation prevention layer comprises:
forming the transparent conductive film and the metal layer on the passivation layer;
forming a double-stepped photoresist having a diffractively exposed section on the metal layer;
patterning the transmissive electrode, the reflective electrode, and the oxidation prevention layer using the photoresist as a mask;
ashing the photoresist to expose the metal layer above the transmissive electrode to the outside; and
etching the metal layer above the transmissive electrode.

6. The method according to claim 5, wherein the transparent conductive film of transmissive electrode remains when the metal layer above the transmissive electrode is etched.

7. The method according to claim 1, wherein the transmissive electrode, the reflective electrode, and the oxidation prevention layer are formed by performing using a photo-etching twice.

8. The method according to claim 7, wherein the step of forming the transmissive electrode, the reflective electrode, and the oxidation prevention layer by performing the photo-etching twice comprises:
depositing the transparent conductive film on the passivation layer;
patterning the transparent conductive film to form the transmissive electrode and a first oxidation prevention layer;
depositing a metal layer over an entire surface including the transmissive electrode and the first oxidation prevention layer;
patterning the metal layer to form the reflective electrode; and
forming a second oxidation prevention layer on the first oxidation prevention layer.

9. The method according to claim 8, wherein the metal layer above the transmissive electrode is etched when the metal layer is patterned.

10. The method according to claim 1, wherein the step of forming the thin film transistor comprises:
forming the gate electrode at the same time of forming the gate line;
forming a gate insulation layer on the gate electrode;
forming a semiconductor layer on the gate insulation layer above the gate electrode; and
forming source/drain electrodes at the same time of forming the data line.

11. The method according to claim 10, wherein the semiconductor layer, the data line, and the source/drain electrodes are simultaneously formed using the photo-etching technique using a diffractive exposure mask.

12. The method according to claim 1, further comprising forming grooved patterns at the reflective portion of the unit pixel region.

13. The method according to claim 12, wherein the reflective electrode is formed along curved features of the grooved pattern.

14. The method according to claim 12, wherein the grooved patterns are formed by patterning an insulation layer.

15. The method according to claim 1, wherein the transmissive electrode is connected to the drain electrode of the thin film transistor through the contact hole.

16. The method according to claim 15, wherein the reflective electrode is connected to the transmissive electrode.

17. The method according to claim 16, wherein the transparent conductive film under the reflective electrode is connected integrally to the transmissive electrode.

18. The method according to claim 1, wherein the metal layer on the oxidation prevention layer is formed of a material selected from Cu, Al, Al alloy (AlNd), Mo, Cr, Ti, Ta, and MoW.

19. The method according to claim 1, wherein the transparent conductive film on the oxidation prevention layer includes ones of ITO and IZO.
